(19) United States
(12) Patent Application Publication
(10) Pub. No.: US 2025/0045586 A1
(43) Pub. Date: Feb. 6, 2025

(54) METHOD AND APPARATUS FOR ACCELERATING DEEP LEANING INFERENCE BASED ON HW-AWARE SPARSITY PATTERN

(71) Applicant: Intel Corporation, Santa Clara, CA (US)

(72) Inventors: Hengyu MENG, Shanghai (CN); Jiong GONG, Shanghai (CN); Xudong LIU, Shanghai (CN); Haihao SHEN, Shanghai (CN)

(21) Appl. No.: 18/717,275

(22) PCT Filed: Mar. 4, 2022
(86) PCT No.: PCT/CN2022/079424

§ 371 Date: Jun. 6, 2024

(51) Int. Cl. G06N 3/082

(52) U.S. Cl. CPC G06N 3/082

(57) ABSTRACT

The application provides a method and apparatus for accelerating deep learning inference based on a HW-aware sparsity pattern. The method may include determining a hardware-aware sparsity pattern based on a register width specified by an ISA of a hardware unit for implementing the DNN for deep learning inference, the sparsity pattern specifying a block size and a sparsity ratio for block-wise sparsification of a weight matrix of an operator in the DNN; performing the block-wise sparsification for the weight matrix based on the sparsity pattern to obtain a sparse weight matrix, during a training process of the DNN; compressing the sparse weight matrix into a concentrated weight matrix by removing all-zero blocks from the sparse weight matrix; and generating a mask to indicate an index of each row of non-zero blocks in the sparse weight matrix to enable extraction of corresponding elements from an activation matrix of the operator.

### TECHNICAL FIELD

Embodiments described herein generally relate to deep neural network (DNN), and more particularly relate to a method and an apparatus for accelerating deep learning inference based on a hardware (HW) aware sparsity pattern.

### BACKGROUND

Deep neural networks (DNNs) have been rapidly improving in recent years and shown state-of-the-art (SOTA) accuracy for a wide range of tasks. However, the DNNs still face challenges during industrial deployment due to high computational cost of inference. Most DNN workloads include computation intensive operations such as General Matrix Multiple (GEMM) and convolution. These operations are basically foundation of the DNNs and consume most time during deep learning inference.

### BRIEF DESCRIPTION OF THE DRAWINGS

The various advantages of the embodiments will become apparent to one skilled in the art by reading the following specification and appended claims, and by referencing the following drawings, in which:

FIG. 1 illustrates various sparsity patterns that may be applied for accelerating deep learning inference;

FIG. 2 illustrates an example sparse weight matrix in a shape of K×N with a 4-in-64 sparsity pattern according to some embodiments of the disclosure;

FIG. 3 illustrates an example sparse GEMM operation between an activation matrix and a sparse weight matrix according to some embodiments of the present disclosure;

FIG. 4 illustrates an example compression process for generating a concentrated weight matrix according to some embodiments of the disclosure;

FIG. 5 illustrates an example concatenated activation matrix according to some embodiments of the disclosure;

FIG. 6 illustrates an example sparse GEMM operation based on a dot product between a concatenated activation matrix and corresponding non-zero blocks in a sparse weight matrix according to some embodiments of the disclosure;

FIG. 7 illustrates an example process for implementing a sparse GEMM with SVE ISA according to some embodiments of the disclosure;

FIG. 8 is a block diagram illustrating components, according to some example embodiments, able to read instructions from a machine-readable or computer-readable medium and perform any one or more of the methodologies discussed herein;

FIG. 9 is a block diagram of an example processor platform in accordance with some embodiments of the disclosure; and

FIG. 10 illustrates an example flowchart of a procedure for accelerating deep learning inference based on a hardware-aware sparsity pattern according to some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

Although DNNs have been rapidly improving in recent years for a wide range of computation tasks, it still faces challenges during industrial deployment due to its high computational cost of inference. Most DNN workloads include computation intensive operations such as GEMM and convolution, and these operations are foundation of the DNNs and consume most time during deep learning inference.

Sparsification is a promising optimization technique to reduce the computational cost and memory footprint for deep learning workloads. Typically, a sparse matrix or a sparse tensor is a matrix in which most of the elements are zeroes.

There are many academia and industrial efforts on sparsification or compression in recent years, and a sparsity pattern is the key of sparsification. For example, Nvidia introduced a sparsity hardware in Ampere architecture (e.g., A100). With the sparsity hardware, a 2-in-4 structured sparsity pattern was successfully applied in typical deep learning models and the overall performance gain is about 1.5× while keeping the accuracy within 1% loss. In addition, some other works focused more on unstructured sparsity patterns.

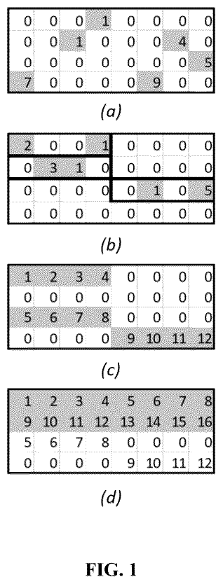

FIG. 1 illustrates various sparsity patterns that may be applied for accelerating deep learning inference. Specifically, as shown in FIG. 1, the sparsity pattern (a) is an element-wise sparsity pattern, the sparsity pattern (b) is the 2-in-4 structured sparsity pattern introduced by Nvidia, the sparsity pattern (c) is a block-wise sparsity pattern, and the sparsity pattern (d) is a channel-wise sparsity pattern.

In general, the more structured the sparsity pattern is, the less accuracy loss and higher performance gain the sparsity pattern will bring. Therefore, it is a tradeoff among sparsity ratio, accuracy, and performance. As mentioned above, NVIDIA's 2-in-4 sparsity pattern may be a successful solution which means to divide a matrix into many 1×4 vectors and for each vector there are always 2 zeros and 2 non-zeros. The NVIDIA's solution is more structured than the element-wise sparsity, which means with the specific hardware support, Artificial Intelligence (AI) applications can achieve a 1.3×-1.5× speed up, and meanwhile the sparsity pattern is unstructured enough to maintain the accuracy.

However, it is obvious that the NVIDIA's solution cannot be applied to most existing modern Single Instruction Multiple Data (SIMD) Instruction Set Architectures (ISAs) both on a Central Processing Unit (CPU) and a Graphic Processing Unit (GPU), including AVX-X series ISA (AVX2, AVX512, AVX512VNNI) introduced from 2nd generation Intel® Xeon® Scalable Processors and AMD EPYC™ Processors, Intel® Advanced Matrix Extension (AMX) introduced from 4th generation Intel® Xeon® Scalable Processors, DP4A/XMX introduced from Intel® Xe GPU, and NEON/SVE introduced by ARM. On the other hand, the 2-in-4 sparsity pattern sets a maximum limit for the sparsity ratio which in turn sets an upper limit of sparsification acceleration. Also, NVIDIA's solution cannot fully utilize general SIMD ISA capabilities which are usually designed for dense operations

Without native sparsity hardware support, when implementing the DNN for deep learning inference on a hardware unit with the existing modern SIMD ISA, it may be a solution to rely on software optimization to bring the performance gains based on a reasonable sparsity ratio. For example, oneAPI Math Kernel Library (oneMKL) can accelerate the GEMM computation given an extremely high sparsity ratio greater than 99%.

In this disclosure, a general HW-aware sparsity pattern for hardware units with SIMD capabilities is proposed based on a sparsification and kernel optimization method, which can fully leverage existing dense vector/matrix hardware capabilities to achieve promising performance speed up by using just software solutions. The granularity of the sparsity pattern may well maintain the accuracy and bring a much better performance gain (e.g. 5×-10×) on kernel level compared with 1.5× that NVIDIA got with its A100 hardware solution.

The method may be used to accelerate deep learning inference on hardware ISAs such as Intel DL Boost including VNNI starting from 2nd generation Intel® Xeon® Scalable Processors, AMX on future generation of Intel® Xeon® Scalable Processors, and even more SIMD ISAs from ARM, AMD, or NVIDIA. These SIMD ISAs are all based on a fixed register length. For example, VNNI provides INT8 registers organized by a register shape of 4×16, AMX provides BF16 registers as a shape of 16×32 and INT8 registers as a shape of 16×64, and NEON from ARM provides uint8 vectors with a shape of 1×16. It is necessary and possible to design a sparsification solution to fully utilize these advance ISA capabilities.

According to some embodiments of the disclosure, a HW-aware sparsity pattern may be firstly determined based on a register width specified by the ISA of the hardware unit for implementing the DNN for deep learning inference. The sparsity pattern may specify a block size and a sparsity ratio for block-wise sparsification of a weight matrix of an operator in the DNN. Taking the AVX512 ISA introduced from Intel® Xeon® Scalable Processors as an example, the AVX512 ISA specifies a 512-bit register width, and for a data type of FP32, the AVX512 ISA provides vectors with a register shape of 1×16. In this case, the sparisty pattern may specify a block size of 1×16, and the weight matrix can be divided into many 1×16 blocks and each block may contain all zeroes or contain non-zero elements. A block containing all zeroes may be referred to as an all-zero block, and a block containing non-zero elements may be referred to as a non-zero block. The sparsity ratio may be defined as the number of all-zero blocks divided by the total numbers of blocks in the matrix.

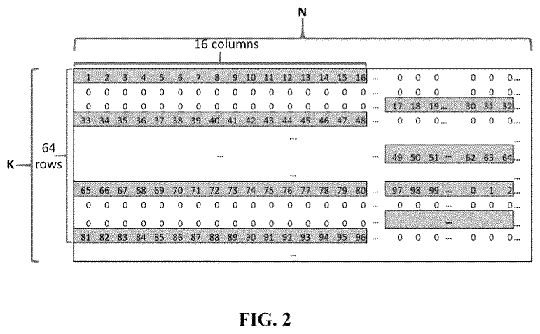

Among all more general sparsity patterns specifying a block size of 1×16, a specific 4-in-64 sparsity pattern designed for VNNI is firstly introduced as an example. FIG. 2 illustrates an example sparse weight matrix in a shape of K×N with a 4-in-64 sparsity pattern according to some embodiments of the disclosure. For example, assume the weight matrix B is in a shape of K×N, where K is the height of the weight matrix or the number of input channels of a linear layer in the DNN, and N is the width of the weight matrix or the number of output channels of the linear layer. When performing the deep learning inference with the DNN, the weight matrix may be multiplied by an input matrix (also referred to as an activation matrix herein) which is in a shape of M×K, where M is the height of input matrix or the batch size.

It is noted that in this disclosure, the description about the proposed optimization methodology is focused on the inference of linear layers in the DNN which basically involves a GEMM operation between an input matrix/tensor A and a weight matrix B. For the GEMM operation, the weight matrix B may be trained during a training process of the DNN based on the HW-aware sparsity pattern into a sparse weight matrix with the sparsity pattern. It should be understood that the proposed optimization methodology can be easily adopted for the convolution operation as well after an img2col operation configured to transform the convolution operation into the GEMM operation.

As shown in FIG. 2, the 4-in-64 sparsity pattern may be designed for the AVX512VNNI for the INT8 data type. The AVX512VNNI provides the INT8 data vector in a register shape of 4×16. Accordingly, the sparsity pattern may specify a block size of 1×16 and a sparsity ratio of 4/64. For example, assume that K and N can separately be divided by 64 and 16 (padding if needed), i.e., k=K/64, n=N/16, then the weight matrix may be divided into k×n big blocks. In each big block, there are 60 all-zero 1×16 blocks and 4 non-zero blocks, and each block is in the shape of 1×16. In other words, the weight matrix may be divided into many blocks of 1×16, 4 of every 64 blocks are non-zero blocks, and 60 of the 64 blocks are all-zero blocks.

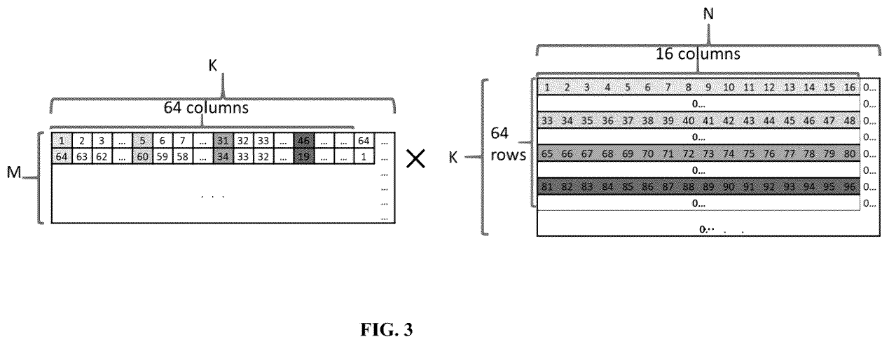

FIG. 3 illustrates an example sparse GEMM operation between an activation matrix and a sparse weight matrix according to some embodiments of the present disclosure. As shown in FIG. 3, the activation matrix is a dense matrix and the weight matrix is a sparse matrix with the HW-aware sparsity pattern. According to some embodiments of the disclosure, in order to fully leverage existing dense vector/matrix hardware capabilities, the sparse weight matrix may be compressed into a concentrated weight matrix for the deep learning inference by removing all-zero blocks from the sparse weight matrix.

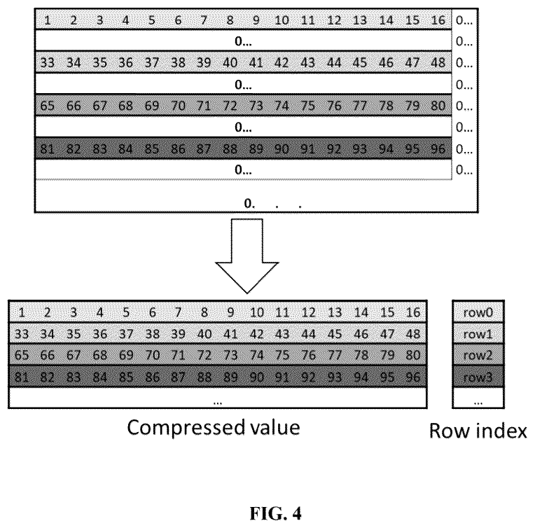

FIG. 4 illustrates an example compression process for generating a concentrated weight matrix according to some embodiments of the disclosure. As shown in FIG. 4, only four 1×16 non-zero blocks of every sixty-four 1×16 blocks in the weight matrix are retained in the concentrated weight matrix. Meanwhile, a mask may be generated to indicate an index of each row of non-zero blocks in the sparse weight matrix to enable extraction of corresponding elements from an activation matrix of the operator during the deep learning inference. It is noted that the compression process may be executed only once before the inference.

With the mask for indicating an index of each row of non-zero blocks in the sparse weight matrix, when performing the GEMM operation for the inference, the elements in the activation matrix may be firstly loaded and then the elements corresponding to the non-zero blocks of the sparse weight matrix may be extracted from the activation matrix based on the mask.

For example, for the GEMM operation in FIG. 3, since the big block in the weight matrix is in the shape of 64×16, for the first row, 64 elements may be loaded in one time which just fit in a cache line in a single AVX512 intrinsic A=_mm512_load_epi32(memory_addr_of_row_head) to get a vector A including the 64 elements, and then 4 elements corresponding to the non-zero blocks of the sparse weight matrix may be extracted in another single AVX512 intrinsic A_extracted=_mm512_maskz_compress_epi8(mask, A) to get a vector A_extracted including the 4 elements. It is noted that the intrinsic _mm512_maskz_compress_epi8 is a new intrinsic introduced by AVX512-VBMI2, as one of new features of 3rd generation Xeon Scalable Processors.

In order to be aligned with the register width of VNNI, the extracted elements may be broadcast to generate a concatenated activation matrix. FIG. 5 illustrates an example concatenated activation matrix according to some embodiments of the disclosure. As shown in FIG. 5, the four extracted elements may be broadcast to generate the 1×64 concatenated activation matrix containing 16 copies of the four extracted elements. When performing the inference, the GEMM operation between the activation matrix and the weight matrix may be easily and efficiently realized by calculating a dot product between the concatenated activation matrix obtained as above and corresponding non-zero blocks in the sparse weight matrix. For example, the dot product may be executed in a single AVX512VNNI intrinsic_mm512_dpbusds_epi32( ).

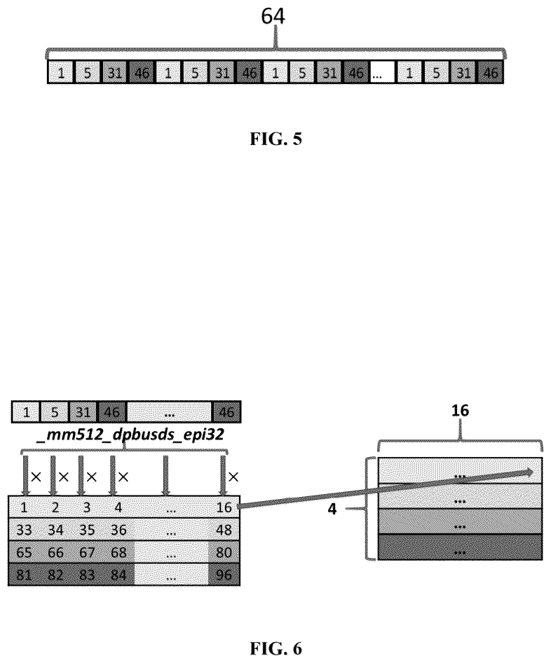

FIG. 6 illustrates an example sparse GEMM operation based on a dot product between a concatenated activation matrix and corresponding non-zero blocks in a sparse weight matrix according to some embodiments of the disclosure. As shown in FIG. 6, the dot product between the 1×64 concatenated activation matrix and the corresponding non-zero blocks in the weight matrix can be easily and efficiently computed via the single AVX512VNNI intrinsic _mm512_dpbusds_epi32( ). In the same way, next 1×64 concatenated activation matrixes corresponding to other non-zero blocks in the weight matrix can be generated in sequence. Accordingly, the dot products between these concatenated activation matrixes and their corresponding non-zero blocks in the weight matrix can be computed to obtain respective dot product results, and these results can be added into the same position.

As described above, in the disclosure, an optimization procedure for accelerating deep learning inference based on a HW-aware sparsity pattern is proposed. Generally, the procedure may include the following operations: determining a HW-aware sparsity pattern based on a register width specified by an ISA of a hardware unit for implementing the DNN for deep learning inference, wherein the sparsity pattern specifies a block size and a sparsity ratio for block-wise sparsification of a weight matrix of an operator in the DNN; performing the block-wise sparsification for the weight matrix based on the sparsity pattern to obtain a sparse weight matrix, during a training process of the DNN according to a training dataset received via the interface circuitry; compressing the sparse weight matrix into a concentrated weight matrix for the deep learning inference by removing all-zero blocks from the sparse weight matrix; and generating a mask to indicate an index of each row of non-zero blocks in the sparse weight matrix to enable extraction of corresponding elements from an activation matrix of the operator during the deep learning inference.

Among these operations, the determination of the HW-aware sparsity pattern, the compression of the sparse weight matrix, and the generation of the mask have been described above with reference to FIG. 1 to FIG. 6. Next, the block-wise sparsification based on the sparsity pattern will be described with reference to the pseudo codes in Table 1, which shows an updated training process.

TABLE 1
Updated training process

```
def train( ):
  for x ,label in dataloader:
    y = model(x)
    loss = loss_func(y, label)
    optimizer.zero_grad( )
    loss.backward( )
    prune_{—}gradient_{—}with_{—}magnitude( )
    group_{—}lasso_{—}regularize (alpha) # alpha: sparsification rate
    optimizer.step( )
    lr_scheduler.step( )
    prune_{—}weights_{—}with_{—}magnitude( )
```

The training process in Table 1 is based on a typical training process for the DNN and updated by adding functions for the block-wise sparsification based on the sparsity pattern. L1-normalization may be used to regularize gradients to make the weight matrix tend to be in some sparse format. It is noted that according to the sparsity ratio specified by the sparsity patent, during the training process, grandients of the elements in the weight matrix should be updated according to the formula gradients_{new}=gradients_{origin}+data×ratioₛₚₐᵣₛₑ.

In Table 1, the added functions for the block-wise sparsification are shown in bold. Firstly, the group-lasso algorithm is used in the group_lasso_regularize function. The core idea of the group-lasso algorithm is to divide the weight matrix into many blocks of the block size specified by the sparsity pattern and apply L2 normalization to each block and L1 normalization between different blocks, so as to generate a sparse solution according to the sparsity pattern. Suppose the total number of elements in the weight matrix is N, the weight matrix is divided into K blocks, each block contains M elements, then N=K×M. The formula for the group-lasso regularization is as follows:

$${minimize}_{{θ}_{0} ϵ , {θ}_{j} ϵ {{j}_{}}^{}} \{ \frac{1}{2} {\sum }_{i = 1}^{N} {( {i}_{} - {θ}_{0} - {\sum }_{j = 1}^{J} {z}_{ij}^{T} {θ}_{j} )}^{2} + λ {\sum }_{j = 1}^{J} {‖ {θ}_{j} ‖}_{2} \} ,$$

In the formula, N denotes the total number of elements in the weight matrix, J denotes the number of blocks in the weight matrix. According to the formula, it can be seen that the group-lasso regularization is based on the ridge regression, which is actually a combination of the linear regression for minimizing the cost function and the L2-norm constraint.

In other words, the group_lasso_regularize function applies the group-lasso algorithm to the weight matrix based on the predetermined sparsity pattern to perform the regularization according to the above formula so as to generate a preliminary sparse weight matrix. Specifically, if the weight matrix is not a two-dimensional matrix, then the weight matrix needs to be reshaped into a two-dimensional matrix first. Then according to the above formula for group-lasso, the elements in the weight matrix may be divided into blocks of the block size (e.g. 1×16). Assuming that the shape of the weight matrix is [m,n], then the weight matrix may be reshaped as [m/BlockSize[0], BlockSize[0], n/BlockSize[1], BlockSize[1]]. For example, the torch.norm function may be used to perform L2 regularization calculations on the [1,3] dimensions, and then the torch.repeat_interleave function may be used to expand elements in the missing dimensions. Finally, the calculated group lasso regularization item value is added to the gradient of parameters.

As described above, the group-lasso regularization may be used to generate a preliminary sparse weight matrix, which means that some elements in the weight matrix that should be zeroes according to the predetermined sparsity pattern may be trained to have very low magnitudes but still not zeros. In other words, the group-lasso regularization cannot guarantee that the generated sparse weight matrix fully satisfies the required sparsity pattern.

In view of this issue, a block-based magnitude pruning process may be applied to the preliminary sparse weight matrix to decide whether a block in the weight matrix should be set as an all-zero block based on some kinds of normalization values. For example, the L2-norm constraint can be used. In the training process shown in Table 1, the prune_weights_with_magnitude function may be used to prune elements in the preliminary sparse weight matrix according to a block-based magnitude so as to obtain the sparse weight matrix with the required sparsity pattern.

In some embodiments, the prune_weights_with_magnitude function may determine whether values of elements in a block in the preliminary sparse weight matrix are less than a preset threshold, and set the block as an all-zero block when the values of the elements in the block are less than the preset threshold.

Alternatively, the prune_weights_with_magnitude function may determine a number K of all-zero blocks in the sparse weight matrix according to the sparse pattern and a shape of the weight matrix, select K blocks containing elements with smallest values among all blocks in the weight matrix; and set the K blocks as the all-zero blocks. For example, for a general sparsity pattern specifying a block size of 1×16, if the weight matrix is in the shape of [m,n], then

$$int ( \frac{m}{1} \times \frac{n}{16} \times SparsityRatio )$$

blocks with the smallest values among

$$int ( \frac{m}{1} \times \frac{n}{16} )$$

blocks may be set as the all-zero blocks. But for the specific 4-in-64 sparsity pattern, the weight matrix may be divided into

$$int ( \frac{m}{64} \times \frac{n}{16} )$$

sub-matrixs and for each sub-matrix, 60 blocks with smallest values may be set as the all-zero blocks.

In addition, the training process in Table 1 may further include a prune_gradient_with_magnitude function, which may be used to prune gradients of elements in respective blocks of the weight matrix during the training process to set gradients of elements in a block of the weight matrix to be zero when values of the elements in the block have been trained to be zeroes. Specifically, if the values of elements in a specific block have been trained to be zeroes in an epoch of the training process, the gradients of the elements in the block can be set to be zeroes. This function can be applied to prevent some all-zero blocks obtained in previous epochs of the training process from becoming non-zero blocks in later epochs of the training process because of gradient updates (e.g. Stochastic Gradient Descent (SGD)).

Therefore, according to the updated training process in Table 1, the block-wise sparsification may be realized by combining the group-lasso regularization and the magnitude pruning. As a result, the training process may generate the sparse weight matrix with the predetermined HW-aware sparsity pattern.

Furthermore, it should be understood that the proposed optimization methodology can be easily applied to more SIMD ISAs. Table 2 illustrates a summary of Intel advanced ISAs.

TABLE 2
Summary of Intel advanced ISAs

| ISA Name | HW | Data Type | Shape |
|---|---|---|---|
| AVX512F | 1^{st} + Xeon | FP32 | 1 × 16 |
| AVX512BF16 | 3^{rd} + Xeon (CPX) | BF16 | 2 × 16 |
| AVX512VNNI | 2^{nd} + Xeon (CLX) | INT8 | 4 × 16 |
| AMX-BF16 | 4^{th} + Xeon (SPR) | BF16 | 32 × 16 |
| AMX-INT8 | 4^{th} + Xeon (SPR) | INT8 | 64 × 16 |
| DP4A | Xe (PVC) | INT8, BF16 | 4 × 16, 2 × 16 |
| XMX | Xe (PVC) | INT8, BF16 | 32 × 16, 16 × 16 |

As shown in Table 2, the vector width for all of these ISAs is 16, so the block size for all of these ISAs may be set as 1×16, and the above block-wise sparsification and compression process can be easily applied to these ISAs. But it is noted that the register shapes for these ISAs and different data types may not be the same, so the sparsity ratio may not be the same. To sum up, when the register shape is N×M, the block size should be 1×M, and the sparsity ratio should be preset to make the number of the non-zero blocks in the sparse weight matrix be an integral multiple of N. In this way, the hard-aware sparsity pattern can be determined to specify the block size and the sparsity ratio, and the above block-wise sparsification and compression process based on the determined sparsity pattern can be similarly applied to these ISAs. In addition, the 4-in-64 sparsity pattern for VNNI can be generalized to be an N-in-L pattern, the sparsity ratio is equal to (L−N) divided by L, and L is an integer determined according to the length of the cache line specified by the ISA.

In addition, the proposed optimization methodology can also be applied to more SIMD ISAs such as Tile Matrix Multiply Unit (TMUL), NEON and Scalable Vector Extension (SVE). For the specific 4-in-64 sparsity pattern, actually the “4” is determined from the register width of VNNI and the “64” is determined from the length of a cache line. But for more general workload, it may be not possible to train the weight matrix with such a pattern. For example, the register shape of TMUL is 32×16 (for bfloat16) and 64×16(for int8), so there is no way to concentrate 32 1×16 blocks in a cache line, but the general sparsity pattern specifying a block size of 1×16 can still be used. The above described operations for the 4-in-64 pattern can be similarly used for the TMUL to implement the 1×16 sparse GEMM. Specifically, the weight matrix may be compressed in advance to make the weights contiguously stored in the memory and get related masks. For example, if there are x 1×16 non-zero blocks, then the compressed weight tensors of the x×16 shape and the related x mask indexes can be generated. But it may be not possible to load related elements in activation tensors in one loading, so the load operation may be done in a loop and then the elements may be concentrated together. In addition, if the number of elements cannot be divided by the needed register width, for example, 32 for AMX bfloat16, paddings may be needed. As a result, the compressed weights and selected activation elements in 32×16 patterns can be obtained and the two tensors can be fed into AMX tile computation.

NEON is a SIMD ISA introduced by ARM on its v6 design. NEON has a 128-bit register width, which brings a dot-product capability for 1×4 FP32 vector or 1×16 UINT8 vector. The SIMD registers are organized as a vector, so it may not be needed to concentrate non-zero blocks in GEMM kernels. For the FP32 NEON, a sparse weight matrix may be trained out with a sparsity pattern specifying a block size of 1×4 by use of the above described block-wise sparsification process. Like AVX512, the weight matrix may be divided into 1×4 blocks. The blocks may be all-zero blocks or contain non-zero elements, and then the compression process can be applied to only hold non-zero blocks. The non-zero blocks can do dot-product with related activation elements.

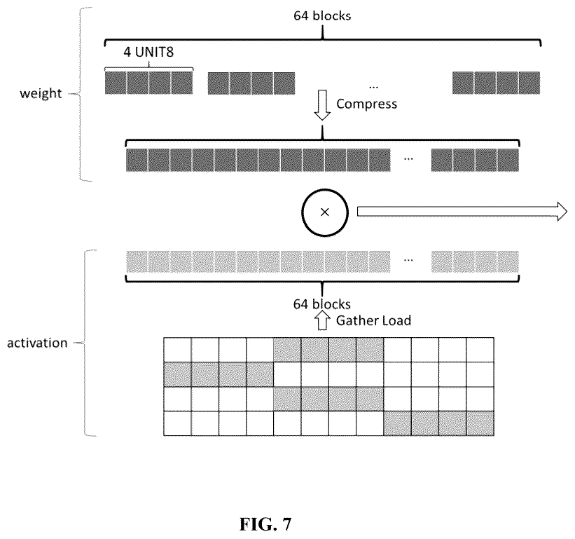

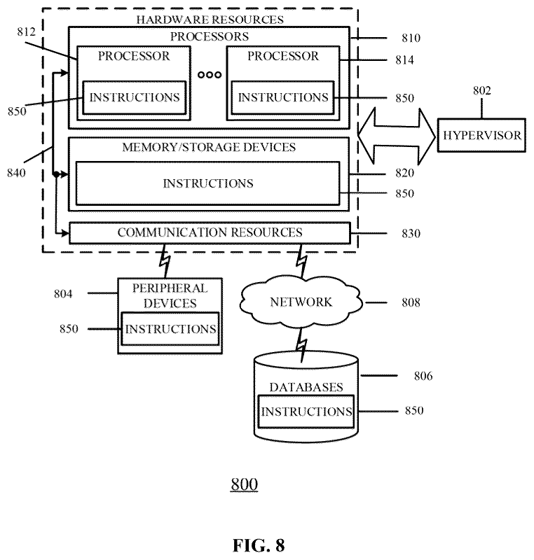

SVE is a new SIMD ISA introduced by ARM with its v8.2 design, but will be adopted by more silicon designs by ARM-V9 as expected. The key feature of SVE is a configurable SIMD register width up to 2048 bits, or 256 UINT8. Apparently, it is hard to train a sparse weight matrix with a sparsity pattern specifying a block size of 1×256, however a concentrated intrinsic can be used to concatenate elements from different vectors, so a sparse GEMM can be implemented based on a sparsity pattern specifying a block size of 1×4. FIG. 7 illustrates an example process for implementing a sparse GEMM with SVE ISA according to some embodiments of the disclosure. As shown in FIG. 7, the weight matrix may be divided into many 1×4 blocks, non-zero blocks in the trained sparse weight matrix may be compressed in to a dense concentrated weight matrix, corresponding activation elements from the activation matrix may be extracted and gathered to generate the concatenated activation matrix, and the dot product between the concentrated weight matrix and the concatenated activation matrix may be computed. It is noted that gather-load is one of key features from SVE which is different from NEON and can be used for generating the concatenated activation matrix.

It is noted that according to the proposed sparsity patterns in this disclosure, the block size is aligned with the register width in one dimension, so the contraction of the extracted activation elements can be performed in just another one dimension. In this way, the advance ISA capabilities can be fully utilized and calculation efficiency can be improved.

About the proposed optimization methodology, the experiment results will be provided using Table 3 to Table 6 to show the benefits of the optimization. For example, during MLPerf1.1 inference challenge, a sparse Deep Learning Recommendation Model (DLRM) with the proposed method is tested, which can bring over 50% performance gain over dense results. Table 3 shows the submitted performance and accuracy for DLRM. It can be seen that sparsification not only brings performance gain but also maintain the accuracy. For the fp32 sparse model, the accuracy is even higher which may be the effect of pruning; for the int8 sparse model, the accuracy drop is also within 0.5%, or 99.5% of baseline. In Table 3, QPS means Query per second.

TABLE 3
Measured results of sparse DLRM for MLPerf1.1

| | Dense(fp32) | Dense(int8) | Sparse(f32) | Sparse(int8) |
|---|---|---|---|---|
| Accuracy | 80.25% | 80.21% | 80.28% | 79.91% |
| Offline | 5732 | 23174 | 8024 | 36883 |
| QPS | | | | |
| Server | NA | 20245 | NA | 30396 |
| QPS | | | | |

In addition, the sparsification also indicates performance gain from projection for more HWs and more workloads, as shown in Table 4 and Table 5.

TABLE 4
Projected Results of BERT on SPR (BS = 64)

| | ICX 1S × 40C | | | | SPR 1S × 56C | | | | SPR 1S × 56C(HBM) | | | |
|---|---|---|---|---|---|---|---|---|---|---|---|---|
| | Op | | | | | | | | | | | |
| | FP32 Dense | | INT8 Dense | | INT8 dense | | INT8 Sparse | | INT8 dense | | INT8 Sparse | |
| Time | % | ms | % | m | % | ms | % | ms | % | ms | % | ms |
| Linear | 65.90% | 158.4 | 41.17% | 57.0 | — | 15 | — | 4 | — | 15 | — | 4 |
| Gelu | 7.29% | 17.5 | 10.02% | 13.9 | — | 10 | — | 10 | — | 4 | — | 4 |
| Copy | 4.28% | 10.3 | 7.12% | 9.9 | — | 6 | — | 6 | — | 3 | — | 3 |
| BMM | 3.90% | 9.4 | 6.56% | 9.1 | — | 2.5 | — | 2.5 | — | 2.5 | — | 2.5 |
| Add | 3.86% | 9.3 | 6.43% | 8.9 | — | 2.5 | — | 2.5 | — | 2.5 | — | 2.5 |
| Others | 14.77% | 35.5 | 28.7% | 39.7 | — | 25 | — | 25 | — | 10 | — | 10 |
| TOTAL | 100.0% | 240.3 | | 138.3 | | 61 | | 50 | | 37 | | 26 |
| Perf Gain | | 1x | | 1.7x | | 3.9x | | 4.8x | | 6.5x | | 9.2x |

TABLE 5
Projected Results of BERT on PVC (BS = 128)

| Op | INT8 Dense | | INT8 Sparse | |
|---|---|---|---|---|
| Time | % | ms | % | ms |
| Linear | 30.1% | 7.1 | 7.95% | 1.4 |
| Gelu | 7.35% | 1.7 | 9.66% | 1.7 |
| Copy | 21.2% | 4.9 | 27.8% | 4.9 |
| BMM | 7.81% | 1.8 | 10.2% | 1.8 |
| Add | 4.70% | 1.1 | 6.25% | 1.1 |
| Others | 28.7% | 6.7 | 38.1% | 6.7 |
| TOTAL | 100.0% | 23.3 | 100% | 17.6 |
| Perf | | 1x | | 1.32x |
| Gain | | | | |

TABLE 6
Projected Results of DLRM on SPR (BS = 32768)

| | ICX 1S × 40C | | | | SPR 1S × 56C | | | | SPR 1S × 56C(HBM) | | | |
|---|---|---|---|---|---|---|---|---|---|---|---|---|
| | Op | | | | | | | | | | | |
| | FP32 Dense | | INT8 Dense | | INT8 dense | | INT8 Sparse | | INT8 dense | | INT8 Sparse | |
| Time | % | ms | % | m | % | ms | % | ms | % | ms | % | ms |
| linear_relu | 81.34% | 2808.5 | 72.55% | 664.8 | — | 170 | — | 75 | — | 170 | — | 75 |
| interaction | 8.31% | 286.6 | 10.56% | 96.8 | — | 60 | — | 60 | — | 25 | — | 25 |
| embedding | 7.25% | 250.2 | 7.13% | 65.4 | — | 40 | — | 40 | — | 15 | — | 15 |
| cat | 1.72% | 59.4 | 6.17% | 56.5 | — | 40 | — | 40 | — | 15 | — | 15 |
| others | 1.38% | 47.6 | 3.59% | 32.9 | | 20 | | 20 | | 10 | | 10 |
| TOTAL | 100.0% | 3448.9 | | 916.3 | | 330 | | 235 | | 235 | | 140 |
| Perf Gain | | 1X | | 3.76X | | 10.5X | | 14.7X | | 14.7X | | 24.6X |

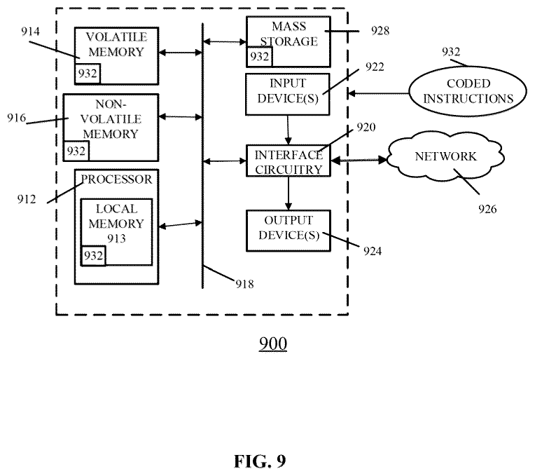

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 820 may include main memory, disk storage, or any suitable combination thereof. The memory/storage devices 820 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 830 may include interconnection or network interface components or other suitable devices to communicate with one or more peripheral devices 804 or one or more databases 806 via a network 808. For example, the communication resources 830 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

FIG. 9 is a block diagram of an example processor platform in accordance with some embodiments of the disclosure. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes interface circuitry 920. The interface circuitry 920 may be implemented by any type of interface standard, such as an Ethernet interface, a universal serial bus (USB), a Bluetooth® interface, a near field communication (NFC) interface, and/or a PCI express interface.

In the illustrated example, one or more input devices 922 are connected to the interface circuitry 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 920 of the illustrated example, thus, typically includes a graphics driver card, a graphics driver chip and/or a graphics driver processor.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 920 may include a training dataset inputted through the input device(s) 922 or retrieved from the network 926.

The processor platform 900 of the illustrated example also includes one or more mass storage devices 928 for storing software and/or data. Examples of such mass storage devices 928 include floppy disk drives, hard drive disks, compact disk drives, Blu-ray disk drives, redundant array of independent disks (RAID) systems, and digital versatile disk (DVD) drives.

Machine executable instructions 932 may be stored in the mass storage device 928, in the volatile memory 914, in the non-volatile memory 916, and/or on a removable non-transitory computer readable storage medium such as a CD or DVD.

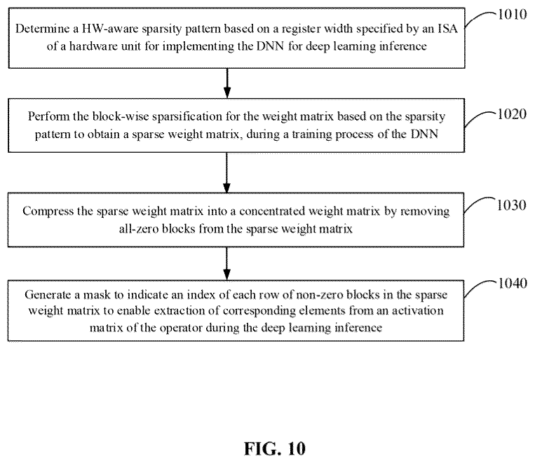

FIG. 10 illustrates an example flowchart of a procedure for accelerating deep learning inference based on a hardware-aware sparsity pattern according to some embodiments of the disclosure. The procedure may be implemented by a processor circuitry and may include operations 1010 to 1040.

At operation 1010, the processor circuitry may determine a hardware-aware sparsity pattern based on a register width specified by an ISA of a hardware unit for implementing the DNN for deep learning inference, the sparsity pattern specifying a block size and a sparsity ratio for block-wise sparsification of a weight matrix of an operator in the DNN.

According to some embodiments of the disclosure, the block size and the sparsity ratio may be preset according to a register shape determined by the register width and a data type of elements in the weight matrix, and the block-wise sparsification may be to divide the weight matrix into blocks of the block size and set a subset of the blocks to be the all-zero blocks according to the sparsity ratio.

According to some embodiments of the disclosure, when the register shape is N×M, the block size may be 1×M and a number of the non-zero blocks in the sparse weight matrix may be an integral multiple of N, where N and M are integers determined by the register width and the data type of elements in the weight matrix.

According to some embodiments of the disclosure, the sparsity pattern may be an N-in-L pattern, the sparsity ratio may be equal to (L−N) divided by L, where L is an integer determined according to a length of a cache line specified by the ISA. In a specific embodiment, the register shape may be 4×16, and the sparsity pattern may be a 4-in-64 pattern.

At operation 1020, the processor circuitry may perform the block-wise sparsification for the weight matrix based on the sparsity pattern to obtain a sparse weight matrix, during a training process of the DNN.

According to some embodiments of the disclosure, the performing the block-wise sparsification may include performing group-lasso regularization on the weight matrix based on the hardware-aware sparsity pattern to generate a preliminary sparse weight matrix; and pruning elements in the preliminary sparse weight matrix according to a block-based magnitude so as to obtain the sparse weight matrix.

According to some embodiments of the disclosure, the pruning elements in the preliminary sparse weight matrix according to the block-based magnitude may include: determining whether values of elements in a block in the preliminary sparse weight matrix are less than a preset threshold; and setting the block as an all-zero block when the values of the elements in the block are less than the preset threshold.

According to some embodiments of the disclosure, the pruning elements in the preliminary sparse weight matrix according to the block-based magnitude may include: determining a number K of all-zero blocks in the sparse weight matrix according to the sparse pattern and a shape of the weight matrix; selecting K blocks containing elements with smallest values among all blocks in the weight matrix; and setting the K blocks as the all-zero blocks, where K is an integer greater than 0.

According to some embodiments of the disclosure, when a register shape specified by the ISA is N×M, the block size may be 1×M, the sparsity pattern is an N-in-L pattern, the sparsity ratio is equal to (L−N) divided by L, and the pruning elements in the preliminary sparse weight matrix according to the block-based magnitude may include: selecting (L−N) blocks containing elements with smallest values among every L blocks in the weight matrix; and setting the (L−N) blocks as the all-zero blocks, wherein N and M are integers determined by the register width and the data type of elements in the weight matrix, and L is an integer determined according to a length of a cache line specified by the ISA.

According to some embodiments of the disclosure, the processor circuitry may prune gradients of elements in respective blocks of the weight matrix during the training process to set gradients of elements in a block of the weight matrix to be zeroes when values of the elements in the block have been trained to be zeroes.

At operation 1030, the processor circuitry may compress the sparse weight matrix into a concentrated weight matrix for the deep learning inference by removing all-zero blocks from the sparse weight matrix.

At operation 1040, the processor circuitry may generate a mask to indicate an index of each row of non-zero blocks in the sparse weight matrix to enable extraction of corresponding elements from an activation matrix of the operator during the deep learning inference.

According to some embodiments of the disclosure, the processor circuitry may extract elements corresponding to the non-zero blocks of the sparse weight matrix from the activation matrix based on the mask, broadcast the extracted elements to generate a concatenated activation matrix aligned with the register width, and apply the concatenated activation matrix and the concentrated weight matrix to the operator so as to perform the deep learning inference based on the DNN.

According to some embodiments of the disclosure, the ISA may include any SIMD ISA available for implementing the DNN to perform the deep learning inference.

According to some embodiments of the disclosure, the operator may include a GEMM or a convolution.

### Additional Notes and Examples

Example 1 includes an apparatus for a deep neural network (DNN), comprising: interface circuitry; and processor circuitry coupled to the interface circuitry and configured to: determine a hardware-aware sparsity pattern based on a register width specified by an Instruction Set Architecture (ISA) of a hardware unit for implementing the DNN for deep learning inference, the sparsity pattern specifying a block size and a sparsity ratio for block-wise sparsification of a weight matrix of an operator in the DNN; perform the block-wise sparsification for the weight matrix based on the sparsity pattern to obtain a sparse weight matrix, during a training process of the DNN according to a training dataset received via the interface circuitry; compress the sparse weight matrix into a concentrated weight matrix by removing all-zero blocks from the sparse weight matrix; and generate a mask to indicate an index of each row of non-zero blocks in the sparse weight matrix to enable extraction of corresponding elements from an activation matrix of the operator during the deep learning inference.

Example 2 includes the apparatus of Example 1, wherein the block size and the sparsity ratio are preset according to a register shape determined by the register width and a data type of elements in the weight matrix, and the block-wise sparsification is to divide the weight matrix into blocks of the block size and set a subset of the blocks to be the all-zero blocks according to the sparsity ratio.

Example 3 includes the apparatus of Example 1 or 2, wherein when the register shape is N×M, the block size is 1×M and a number of the non-zero blocks in the sparse weight matrix is an integral multiple of N, where N and M are integers determined by the register width and the data type of elements in the weight matrix.

Example 4 includes the apparatus of any of Examples 1 to 3, wherein the sparsity pattern is an N-in-L pattern, the sparsity ratio is equal to (L−N) divided by L, and L is an integer determined according to a length of a cache line specified by the ISA.

Example 5 includes the apparatus of any of Examples 1 to 4, wherein the register shape is 4×16, and the sparisty pattern is a 4-in-64 pattern.

Example 6 includes the apparatus of any of Examples 1 to 5, wherein the processor circuitry is configured to perform the block-wise sparsification by: performing group-lasso regularization on the weight matrix based on the hardware-aware sparsity pattern to generate a preliminary sparse weight matrix; and pruning elements in the preliminary sparse weight matrix according to a block-based magnitude so as to obtain the sparse weight matrix.

Example 7 includes the apparatus of any of Examples 1 to 6, wherein the pruning elements in the preliminary sparse weight matrix according to the block-based magnitude comprises: determining whether values of elements in a block in the preliminary sparse weight matrix are less than a preset threshold; and setting the block as an all-zero block when the values of the elements in the block are less than the preset threshold.

Example 8 includes the apparatus of any of Examples 1 to 7, wherein the pruning elements in the preliminary sparse weight matrix according to the block-based magnitude comprises: determining a number K of all-zero blocks in the sparse weight matrix according to the sparse pattern and a shape of the weight matrix; selecting K blocks containing elements with smallest values among all blocks in the weight matrix; and setting the K blocks as the all-zero blocks, where K is an integer greater than 0.

Example 9 includes the apparatus of any of Examples 1 to 8, wherein when a register shape specified by the ISA is N×M, the block size is 1×M, the sparsity pattern is an N-in-L pattern, the sparsity ratio is equal to (L−N) divided by L, and the pruning elements in the preliminary sparse weight matrix according to the block-based magnitude comprises: selecting (L−N) blocks containing elements with smallest values among every L blocks in the weight matrix; and setting the (L−N) blocks as the all-zero blocks, wherein N and M are integers determined by the register width and the data type of elements in the weight matrix, and L is an integer determined according to a length of a cache line specified by the ISA.

Example 10 includes the apparatus of any of Examples 1 to 9, wherein the processor circuitry is further configured to prune gradients of elements in respective blocks of the weight matrix during the training process to set gradients of elements in a block of the weight matrix to be zeroes when values of the elements in the block have been trained to be zeroes.

Example 11 includes the apparatus of any of Examples 1 to 10, wherein the processor circuitry is further configured to: extract elements corresponding to the non-zero blocks of the sparse weight matrix from the activation matrix based on the mask; broadcast the extracted elements to generate a concatenated activation matrix aligned with the register width; and apply the concatenated activation matrix and the concentrated weight matrix to the operator so as to perform the deep learning inference based on the DNN.

Example 12 includes the apparatus of any of Examples 1 to 11, wherein the ISA comprises any Single Instruction Multiple Data (SIMD) ISA available for implementing the DNN to perform the deep learning inference.

Example 13 includes the apparatus of any of Examples 1 to 12, wherein the operator comprises a General Matrix Multiplication (GEMM) or a convolution.

Example 14 includes a method for a deep neural network (DNN), comprising: determining a hardware-aware sparsity pattern based on a register width specified by an Instruction Set Architecture (ISA) of a hardware unit for implementing the DNN for deep learning inference, the sparsity pattern specifying a block size and a sparsity ratio for block-wise sparsification of a weight matrix of an operator in the DNN; performing the block-wise sparsification for the weight matrix based on the sparsity pattern to obtain a sparse weight matrix, during a training process of the DNN; compressing the sparse weight matrix into a concentrated weight matrix by removing all-zero blocks from the sparse weight matrix; and generating a mask to indicate an index of each row of non-zero blocks in the sparse weight matrix to enable extraction of corresponding elements from an activation matrix of the operator during the deep learning inference.

Example 15 includes the method of Example 14, wherein the block size and the sparsity ratio are preset according to a register shape determined by the register width and a data type of elements in the weight matrix, and the block-wise sparsification is to divide the weight matrix into blocks of the block size and set a subset of the blocks to be the all-zero blocks according to the sparsity ratio.

Example 16 includes the method of Example 14 or 15, wherein when the register shape is N×M, the block size is 1×M and a number of the non-zero blocks in the sparse weight matrix is an integral multiple of N, where N and M are integers determined by the register width and the data type of elements in the weight matrix.

Example 17 includes the method of any of Examples 14 to 16, wherein the sparsity pattern is an N-in-L pattern, the sparsity ratio is equal to (L-N) divided by L, and L is an integer determined according to a length of a cache line specified by the ISA.

Example 18 includes the method of any of Examples 14 to 17, wherein the register shape is 4×16, and the sparsity pattern is a 4-in-64 pattern.

Example 19 includes the method of any of Examples 14 to 18, wherein the performing the block-wise sparsification comprises: performing group-lasso regularization on the weight matrix based on the hardware-aware sparsity pattern to generate a preliminary sparse weight matrix; and pruning elements in the preliminary sparse weight matrix according to a block-based magnitude so as to obtain the sparse weight matrix.

Example 20 includes the method of any of Examples 14 to 19, wherein the pruning elements in the preliminary sparse weight matrix according to the block-based magnitude comprises: determining whether values of elements in a block in the preliminary sparse weight matrix are less than a preset threshold; and setting the block as an all-zero block when the values of the elements in the block are less than the preset threshold.

Example 21 includes the method of any of Examples 14 to 20, wherein the pruning elements in the preliminary sparse weight matrix according to the block-based magnitude comprises: determining a number K of all-zero blocks in the sparse weight matrix according to the sparse pattern and a shape of the weight matrix; selecting K blocks containing elements with smallest values among all blocks in the weight matrix; and setting the K blocks as the all-zero blocks, where K is an integer greater than 0.

Example 22 includes the method of any of Examples 14 to 21, wherein when a register shape specified by the ISA is N×M, the block size is 1×M, the sparsity pattern is an N-in-L pattern, the sparsity ratio is equal to (L−N) divided by L, and the pruning elements in the preliminary sparse weight matrix according to the block-based magnitude comprises: selecting (L−N) blocks containing elements with smallest values among every L blocks in the weight matrix; and setting the (L−N) blocks as the all-zero blocks, wherein N and M are integers determined by the register width and the data type of elements in the weight matrix, and L is an integer determined according to a length of a cache line specified by the ISA.

Example 23 includes the method of any of Examples 14 to 22, further comprising: pruning gradients of elements in respective blocks of the weight matrix during the training process to set gradients of elements in a block of the weight matrix to be zeroes when values of the elements in the block have been trained to be zeroes.

Example 24 includes the method of any of Examples 14 to 23, further comprising: extracting elements corresponding to the non-zero blocks of the sparse weight matrix from the activation matrix based on the mask; broadcasting the extracted elements to generate a concatenated activation matrix aligned with the register width; and applying the concatenated activation matrix and the concentrated weight matrix to the operator so as to perform the deep learning inference based on the DNN.

Example 25 includes the method of any of Examples 14 to 24, wherein the ISA comprises any Single Instruction Multiple Data (SIMD) ISA available for implementing the DNN to perform the deep learning inference.

Example 26 includes the method of any of Examples 14 to 25, wherein the operator comprises a General Matrix Multiplication (GEMM) or a convolution.

Example 27 includes a computer-readable medium having instructions stored thereon, wherein the instructions, when executed by processor circuitry, cause the processor circuitry to perform the method of any of Examples 14 to 26.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium, wherein, when the program code is loaded into and executed by a machine, such as a computer, the machine becomes an apparatus for practicing the various techniques. The non-transitory computer readable storage medium may be a computer readable storage medium that does not include signal. In the case of program code execution on programmable computers, the computing system may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Exemplary systems or devices may include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-25. (canceled)

26. An apparatus for a deep neural network (DNN), comprising:
interface circuitry;
computer readable instructions; and
at least one processor circuit to be programmed by the computer readable instructions to:
determine a hardware-aware sparsity pattern based on a register width specified by an Instruction Set Architecture (ISA) of a hardware unit for implementing the DNN for deep learning inference, the sparsity pattern specifying a block size and a sparsity ratio for block-wise sparsification of a weight matrix of an operator in the DNN;
perform the block-wise sparsification for the weight matrix based on the sparsity pattern to obtain a sparse weight matrix, during a training process of the DNN according to a training dataset received via the interface circuitry;
compress the sparse weight matrix into a concentrated weight matrix by removing all-zero blocks from the sparse weight matrix; and
generate a mask to indicate an index of each row of non-zero blocks in the sparse weight matrix to enable extraction of corresponding elements from an activation matrix of the operator during the deep learning inference.

27. The apparatus of claim 26, wherein the block size and the sparsity ratio are preset according to a register shape determined by the register width and a data type of elements in the weight matrix, and one or more of the at least one processor circuit is to perform the block-wise sparsification by dividing the weight matrix into blocks of the block size and setting a subset of the blocks to be the all-zero blocks according to the sparsity ratio.

28. The apparatus of claim 26, wherein when the register shape is N×M, the block size is 1×M and a number of the non-zero blocks in the sparse weight matrix is an integral multiple of N, where N and M are integers determined by the register width and the data type of elements in the weight matrix.

29. The apparatus of claim 28, wherein the sparsity pattern is an N-in-L pattern, the sparsity ratio is equal to (L−N) divided by L, and L is an integer determined according to a length of a cache line specified by the ISA.

30. The apparatus of claim 29, wherein the register shape is 4×16, and the sparsity pattern is a 4-in-64 pattern.

31. The apparatus of claim 26, wherein one or more of the at least one processor circuit is to perform the block-wise sparsification by:
performing group-lasso regularization on the weight matrix based on the hardware-aware sparsity pattern to generate a preliminary sparse weight matrix; and
pruning elements in the preliminary sparse weight matrix according to a block-based magnitude so as to obtain the sparse weight matrix.

32. The apparatus of claim 31, wherein one or more of the at least one processor circuit is to perform the pruning of the elements in the preliminary sparse weight matrix according to the block-based magnitude by:
determining whether values of elements in a block in the preliminary sparse weight matrix are less than a preset threshold; and
setting the block as an all-zero block when the values of the elements in the block are less than the preset threshold.

33. The apparatus of claim 31, wherein one or more of the at least one processor circuit is to perform the pruning of the elements in the preliminary sparse weight matrix according to the block-based magnitude by:
determining a number K of all-zero blocks in the sparse weight matrix according to the sparse pattern and a shape of the weight matrix;
selecting K blocks containing elements with smallest values among all blocks in the weight matrix; and
setting the K blocks as the all-zero blocks, where K is an integer greater than 0.

34. The apparatus of claim 31, wherein when a register shape specified by the ISA is N×M, the block size is 1×M, the sparsity pattern is an N-in-L pattern, the sparsity ratio is equal to (L−N) divided by L, and one or more of the at least one processor circuit is to perform the pruning of the elements in the preliminary sparse weight matrix according to the block-based magnitude by:
selecting (L−N) blocks containing elements with smallest values among every L blocks in the weight matrix; and
setting the (L−N) blocks as the all-zero blocks,
wherein N and M are integers determined by the register width and the data type of elements in the weight matrix, and L is an integer determined according to a length of a cache line specified by the ISA.

35. The apparatus of claim 26, wherein one or more of the at least one processor circuit is to prune gradients of elements in respective blocks of the weight matrix during the training process to set gradients of elements in a block of the weight matrix to be zeroes when values of the elements in the block have been trained to be zeroes.

36. The apparatus of claim 26, wherein one or more of the at least one processor circuit is to:
extract elements corresponding to the non-zero blocks of the sparse weight matrix from the activation matrix based on the mask;
broadcast the extracted elements to generate a concatenated activation matrix aligned with the register width; and
apply the concatenated activation matrix and the concentrated weight matrix to the operator so as to perform the deep learning inference based on the DNN.

37. The apparatus of claim 26, wherein the ISA includes any Single Instruction Multiple Data (SIMD) ISA available for implementing the DNN to perform the deep learning inference.

38. The apparatus of claim 26, wherein the operator includes a General Matrix Multiplication (GEMM) or a convolution.

39. A non-transitory computer-readable medium comprising instructions to cause at least one processor circuit to:
determine a hardware-aware sparsity pattern based on a register width specified by an Instruction Set Architecture (ISA) of a hardware unit for implementing a deep neural network (DNN) for deep learning inference, the sparsity pattern specifying a block size and a sparsity ratio for block-wise sparsification of a weight matrix of an operator in the DNN;
perform the block-wise sparsification for the weight matrix based on the sparsity pattern to obtain a sparse weight matrix, during a training process of the DNN;
compress the sparse weight matrix into a concentrated weight matrix by removing all-zero blocks from the sparse weight matrix; and
generate a mask to indicate an index of each row of non-zero blocks in the sparse weight matrix to enable extraction of corresponding elements from an activation matrix of the operator during the deep learning inference.

40. The non-transitory computer-readable medium of claim 39, wherein the block size and the sparsity ratio are preset according to a register shape determined by the register width and a data type of elements in the weight matrix, and the instructions cause one or more of the at least one processor circuit to perform the block-wise sparsification to divide the weight matrix into blocks of the block size and set a subset of the blocks to be the all-zero blocks according to the sparsity ratio.

41. The non-transitory computer-readable medium of claim 40, wherein when the register shape is N×M, the block size is 1×M and a number of the non-zero blocks in the sparse weight matrix is an integral multiple of N, where N and M are integers determined by the register width and the data type of elements in the weight matrix.

42. The non-transitory computer-readable medium of claim 41, wherein the sparsity pattern is an N-in-L pattern, the sparsity ratio is equal to (L−N) divided by L, and L is an integer determined according to a length of a cache line specified by the ISA.

43. The non-transitory computer-readable medium of claim 42, wherein the register shape is 4×16, and the sparsity pattern is a 4-in-64 pattern.

44. The non-transitory computer-readable medium of claim 39, wherein the instructions cause one or more of the at least one processor circuit to perform the block-wise sparsification by:
performing group-lasso regularization on the weight matrix based on the hardware-aware sparsity pattern to generate a preliminary sparse weight matrix; and
pruning elements in the preliminary sparse weight matrix according to a block-based magnitude so as to obtain the sparse weight matrix.

45. The non-transitory computer-readable medium of claim 44, wherein the instructions cause one or more of the at least one processor circuit to prune the elements in the preliminary sparse weight matrix according to the block-based magnitude by:
determining whether values of elements in a block in the preliminary sparse weight matrix are less than a preset threshold; and
setting the block as an all-zero block when the values of the elements in the block are less than the preset threshold.
